(19) United States
(12) Patent Application Publication
(10) Pub. No.: US 2010/0198739 A1
(43) Pub. Date: Aug. 5, 2010

(54) Instant Genuine Brand Product Authentication

(76) Inventor: Alexander V. Kent, Riverton, NJ (US)

Correspondence Address: Alexander Kent, 2710 New Albany Road, Riverton, NJ, 08077, US

(21) Appl. No.: 12/697,666

(22) Filed: Feb. 1, 2010

Related U.S. Application Data
(60) Provisional application No. 61/149,093, filed on Feb. 2, 2009.

(51) Int. Cl. G06Q 99/00; G06Q 30/00; G06F 17/30

(52) U.S. Cl. 705/310; 705/318; 707/802; 707/769; 707/E17.044; 707/E17.014

(57) ABSTRACT

This invention implements a process for a genuine brand name product(s) authentication on the spot—both physical market places of all kinds worldwide, and virtual/Internet-based retailers, auctioneers and such—conducted for genuine mobile devices (cell phones, mobile phones, any mobile communication equipment and/or combinations thereof; any known or future stationary communication equipment including but not limited to desktop, laptop, notebook personal/corporate computers/stations and/or variations thereof); for genuine pharmaceutical drugs/medications/medicine and devices; and for any other genuine products, legitimate manufacturers of which suffer losses due to the counterfeiting and piracy activities worldwide.

The authentication is done by means of electronic text messaging (SMS) to-and-from an Internet-based database and using the respective manufacturer/authenticator-assigned unique I.D.'s (similar, but not limited, to IMEI for mobile devices of all kinds).

### RELATED APPLICATIONS

This application claims the priority benefits of the provisional application #61149093 filed on Feb. 2, 2009 under same inventor's name, entitled Electronic instant genuine brand product authentication process.

This invention will save hundreds of dollars to each consumer, hundreds of billions to the genuine products manufacturers, and millions of jobs, which otherwise are being lost to the counterfeit activities worldwide.

### BACKGROUND OF THE INVENTION

1. Field of the Invention

This invention relates to the process for authenticating genuine brand products of legitimate manufacturers, which utilizes the combination of mobile/stationary technology, SMS/text messaging and the Internet-based data storage, comprised of unique identification numbers of the genuine brand products assigned to each item either by its respective manufacturers, or by the authenticating entity, or by a third party.

In order to authenticate an item before acquiring it, a consumer simply locates the unique identification number assigned to the item, then inserts that number into a text message/SMS and sends it to the database through a dedicated number, local to the territory of the request origination.

The database conducts a search within itself if the number in the request belongs to a genuine brand product, manufactured by a legitimate entity. Upon the completion of the search, a response is sent back to the mobile device of the original sender informing whether the identification number is registered with the genuine product manufacturer or not. (In case when a mobile communication equipment is being authenticated—then its IMEI number is to be sent to the database. Similarly, other genuine products are assigned their ID numbers by respective manufacturers, or—where it applies—by the authenticity provider or by a third party.)

The whole process is done electronically and in a short period of time.

2. Description of the Related Art

The sales of counterfeit cell/mobile phones and medicine is a vast and growing problem world-wide, estimated to cost manufacturers hundreds of billions of dollars a year in lost revenue. In addition to lost revenue and the market share to legitimate manufacturers, the consumers are unknowingly purchasing an inferior product with many non-functioning features, a reduced product life span and the potential dangerous due to non-compliance.

In many markets worldwide, up to 50-65% of the mentioned products are counterfeit. That is true especially for the developing and emerging countries.

The legitimate manufacturers worldwide are losing their market share, leading to hundreds of billions in lost revenues; millions of jobs are being lost in the process, too.

Many of existing counterfeit programs and devices are either not as effective, or are counterfeited as well. Almost none of them involve consumers in protecting the consumers.

### SUMMARY OF THE INVENTION

The present invention invites consumers to be involved into supporting legitimate, and therefore, safe to use genuine brand products. This simple technique is widely used by the world's population—sending and receiving text messages/SMS, which allows consumers to save significant amounts of their funds. It allows the manufacturers to save their market share, their production volumes and to protect their intellectual property. It also allows the law enforcement agencies to keep track of the concentration of counterfeit activities to neutralize them on a more effective basis.

The featured process employs the existing methods of providing the consumers with the crucial information about the genuine products. The proven fact is that counterfeit products are unsafe, they do not provide the services the consumer is looking in a genuine product. The counterfeit devices do not last long, and that alone drives the consumers' expenses up. Whereas, the genuine products are safe, last long, have warranty and have many more features vs. the counterfeit products.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. It will be recognized that the terms “comprising,” “including,” and “having,” as used herein, are specifically intended to be read as open-ended terms of art. All documents cited herein are incorporated in their entirety herein.

1. The Instant Genuine Brand Product Authentication process is based on the round-trip SMS/text messaging, initiated in any part of the world, to the Internet-based interactive database of stored unique ID numbers of genuine products manufactured by the legitimate genuine brand products manufacturers.

2. According to claim 1—the database of unique identification numbers is being comprised with the data directly from the respective manufacturers for genuine brand product authentication purposes, and is being updated continuously. Such unique identification numbers may be the existing ones, assigned to an item/device—similar to the IMEI numbers used in the mobile communication devices industry.

3. The network of local short phone numbers worldwide is established to serve the purposes, indicated in claim 1.

4. The information and marketing of the Internet-based interactive database is written in 7-12 most spoken languages in order to provide the authentication services to billions of consumers worldwide, created to support claim 1.

5. The process of the Instant Genuine Brand Product Authentication, in order to support claim 1, can be conducted/executed anywhere in the world, including but not limited to:
the actual market places worldwide; the Internet-based retailers (examples are eBay, Amazon, Craigslist and the rest); as well as at the traditional retailers outlets/facilities.

6. The Instant Genuine Brand Product Authentication process, according to claim 1, is used:
To assist consumers in identifying whether the product/device they are about to purchase is a genuine brand product and, therefore, is safe to use and the manufacturer stands behind it, or it is a counterfeit and is rather unsafe and a short-lived product.
To protect the consumers against the financial, physical, psychological, and moral losses to unsafe and poorly and illegally manufactured products;
To protect the legitimate genuine product manufacturers' intellectual property, and to saving their market share vs. it being lost to growing counterfeiting and piracy;
To other purposes of protecting the manufacturers of their respective genuine brand products.

7. The entire Instant Genuine Brand Product Authentication Process, including an initial text message/SMS request, the transfer of the request to the database, the search within the database, and the feedback message (SMS) to the originator of the request are intended to take just a few minutes, which allows the consumers to avoid acquiring a counterfeit product.
